(19) United States
(12) Patent Application Publication
(10) Pub. No.: US 2006/0080691 A1
(43) Pub. Date: Apr. 13, 2006

(54) Optical disk drive with protected pick-up unit

(75) Inventors: Hsien-Tsung Chiu, Taoyuan County (TW); Chih-Wei Tsao, Taoyuan County (TW); Chun-Ting Chen, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/229,520

(22) Filed: Sep. 20, 2005

(30) Foreign Application Priority Data
Sep. 30, 2004 (TW) 93129569

(51) Int. Cl. G11B 7/08

(52) U.S. Cl. 720/676

(57) ABSTRACT

An optical disk drive with a protected pick-up unit. The optical disk drive includes a core body, a guide bar, a pick-up unit and an impact-reducing mechanism. The core body has an operating zone. The guide bar is connected to the core body. The pick-up unit is movably supported by the guide bar to access an optical disk in the operating zone. The impact-reducing mechanism is disposed outside the operating zone to sustain impact of the pick-up unit when the pick-up unit moves outside the operating zone and collides with the impact-reducing mechanism.

### BACKGROUND

The invention relates to an optical disk drive capable of protecting the pick-up unit thereof during transport.

FIG. 1A depicts a core body 11 of an optical disk drive 1, wherein a pair of parallel guide bars 13, 14 are connected to the core body 11. FIG. 1B depicts an end of the guide bar 14, observed in direction A of FIG. 1A, wherein the end of the guide bar 14 is pressed by a resilient piece 15 on the top, supported by a screw 16 on the bottom, and held by a holder 113 on both sides. The end surface 141 of the guide bar 14 abuts a support 111. Thus, the end of the guide bar 14 is confined to the core body 11.

Other ends of the guide bars 13, 14 are confined to the core body 11 in the same or similar manner.

Referring again to FIG. 1A, a pick-up unit 12 is movably supported by the parallel guide bars 13, 14 via ears 121, 122 thereof. During operation, the pick-up unit 12 moves back and forth along the guide bars 13, 14 to access an optical disk (not shown) in an operating zone R.

It is noted that the pick-up unit 12 is not fixed to the core body 11, and thus may rock on the guide bars 13, 14 during transport. When an external impact to the optical disk drive occurs, the pick-up unit 12 may be damaged due to a collision between the ear 122 of the pick-up unit 12 and the holder 113.

### SUMMARY

To solve the described problem, the invention provides an optical disk drive capable of protecting the pick-up unit thereof during transport.

An optical disk drive in accordance with an exemplary embodiment of the invention includes a core body, a guide bar, a pick-up unit and an impact-reducing mechanism. The core body has an operating zone. The guide bar is connected to the core body. The pick-up unit is movably supported by the guide bar to access an optical disk in the operating zone. The impact-reducing mechanism is disposed outside the operating zone to sustain an impact of the pick-up unit when the pick-up unit moves outside the operating zone and collides with the impact-reducing mechanism, thereby protecting the pick-up unit.

### BRIEF DESCRIPTION OF THE DRAWINGS

The invention can be more fully understood by reading the subsequent detailed description and examples with references made to the accompanying drawings, wherein:

FIG. 1A is a perspective view of a core body of an optical disk drive introduced in the background of the invention;

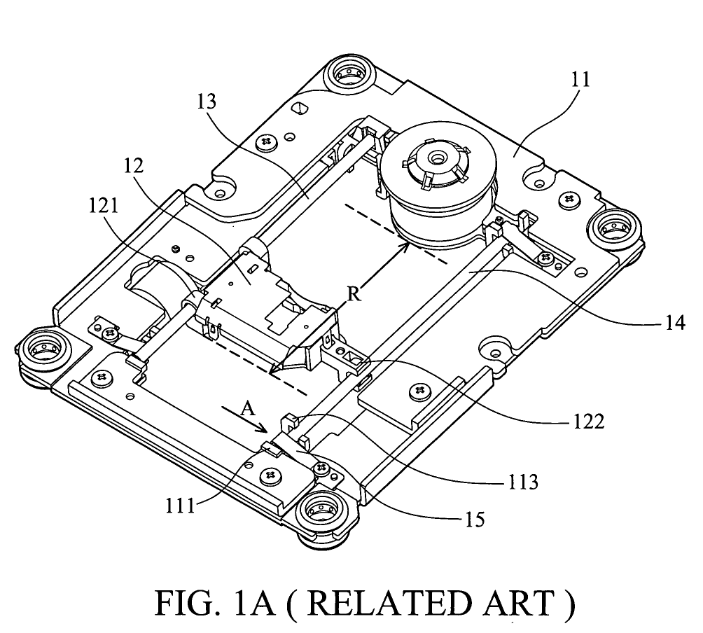

FIG. 1B depicts an end of a guide bar of the core body of FIG. 1A, observed in direction A;

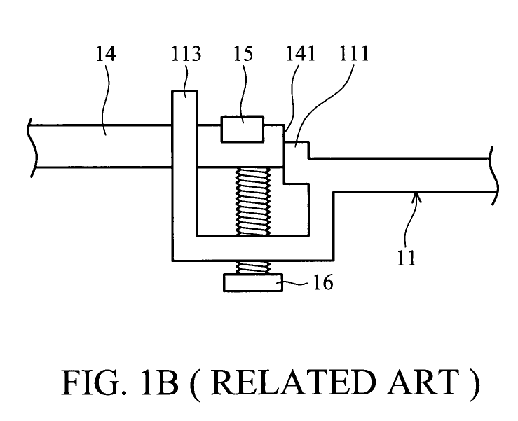

FIG. 2A is a perspective view of a core body of an optical disk drive in accordance with an embodiment of the invention;

FIG. 2B depicts the impact-reducing mechanism of the optical disk drive of FIG. 2A;

FIG. 3A is a perspective view of a core body of an optical disk drive in accordance with another embodiment of the invention;

FIG. 3B depicts the impact-reducing mechanism of the optical disk drive of FIG. 3A;

FIG. 4A is a perspective view of a core body of an optical disk drive in accordance with another embodiment of the invention; and

FIG. 4B depicts the impact-reducing mechanism of the optical disk drive of FIG. 4A.

### DETAILED DESCRIPTION

[An Embodiment]

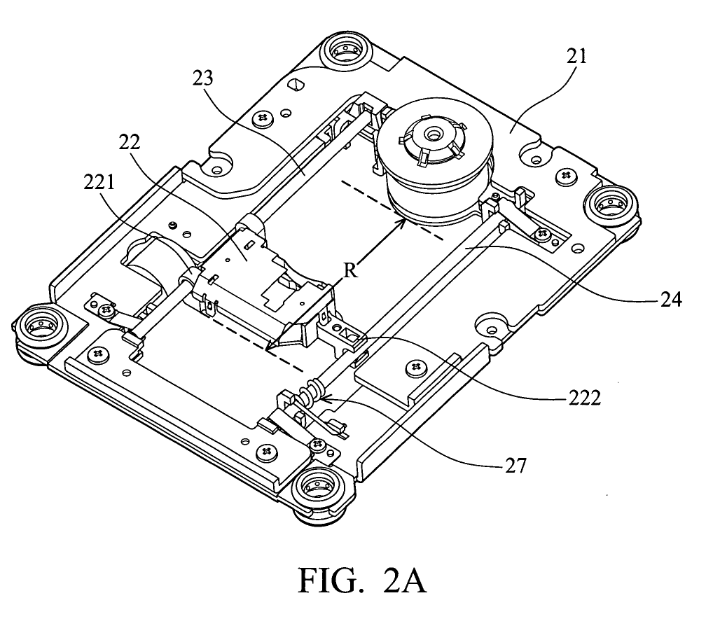

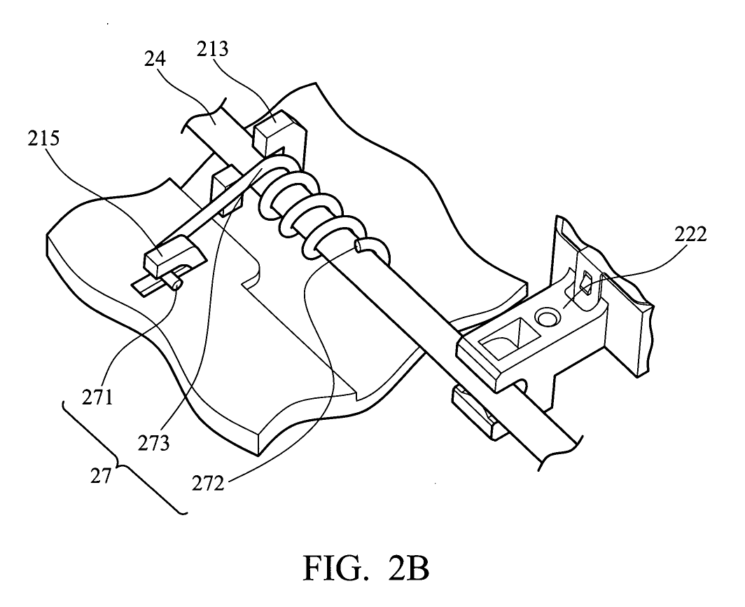

FIG. 2A depicts a core body 21 of an optical disk drive 2, wherein a pair of parallel guide bars 23, 24 are connected to the core body 21. A pick-up unit 22 is movably supported by the parallel guide bars 23, 24 via ears 221, 222 thereof. During operation, the pick-up unit 22 moves back and forth along the guide bars 23, 24 to access an optical disk (not shown) in an operating zone R.

An impact-reducing mechanism 27 is provided outside the operating zone R. In this embodiment, the impact-reducing mechanism 27 is a metallic helical spring wound around the guide bar 24. Referring again to FIG. 2B, the helical spring 27 has a first end 271 hooked to a protrusion 215 of the core body, a second end 272 left free, and a portion 273 abutting a holder 213 of the core body.

During transport, the pick-up unit 22 may move outside the operating zone R along the guide bars 23, 24 and collide with the helical spring 27. When a collision between the pick-up unit 22 and the helical spring 27 occurs, the helical spring 27 would be compressed and absorb the impact of the pick-up unit 22, thereby protecting the pick-up unit 22.

[Another Embodiment]

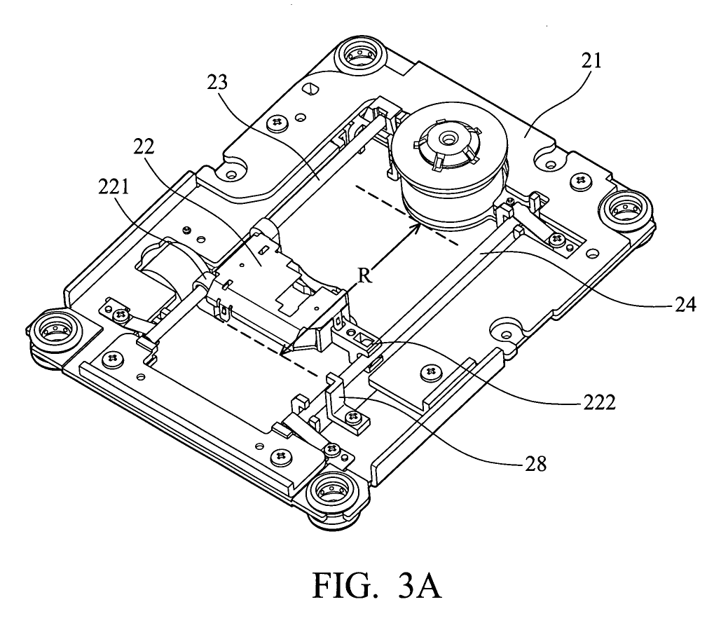

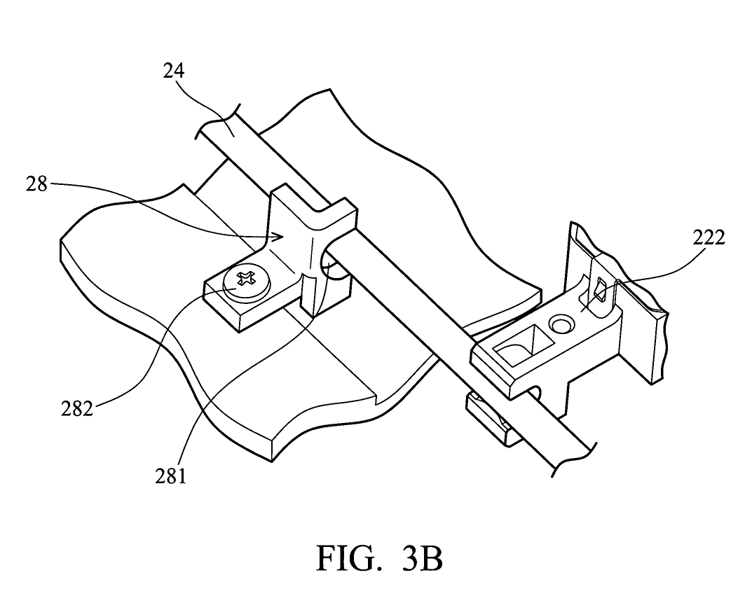

Please refer to FIGS. 3A and 3B, wherein previously referenced elements share the same reference numerals and description thereof is omitted.

An impact-reducing mechanism 28 is provided outside the operating zone R. In this embodiment, the impact-reducing mechanism is a metallic spring band fastened to the core body 21 via a screw 282. The spring band 28 extends from the core body 21 to the guide bar 24 and has a notch 281 allowing the guide bar 24 to pass therethrough.

During transport, the pick-up unit 22 may move outside the operating zone R along the guide bars 23, 24 and collide with the spring band 28. When a collision between the pick-up unit 22 and the spring band 28 occurs, the spring band 28 would be deformed and absorb the impact of the pick-up unit 22, thereby protecting the pick-up unit 22.

[Another Embodiment]

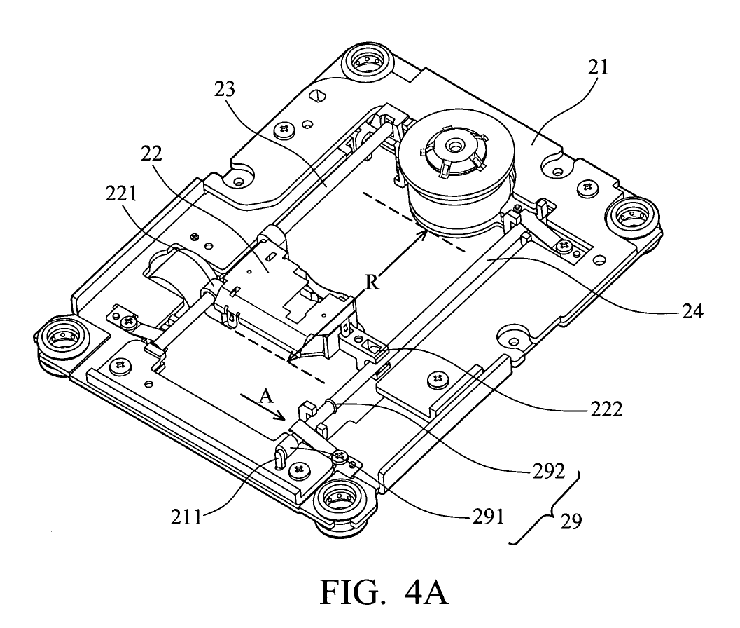

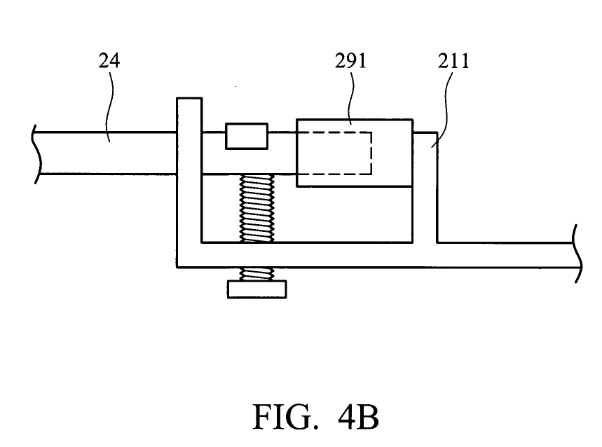

Please refer to FIG. 4A, wherein previously referenced elements share the same reference numerals and description thereof is omitted.

An impact-reducing mechanism 29 is provided outside the operating zone R. In this embodiment, the impact-reducing mechanism 29 includes a rubber buffer 291 and a metallic stopper 292 closer to the pick-up unit 22 than the rubber buffer 291. The stopper 292 is ring-shaped and firmly wound around the guide bar 24. Also referring to FIG. 4B, the buffer 291 covers an end of the guide bar 24 and abuts the support 211 of the core body.

During transport, the pick-up unit 22 may move outside the operating zone R along the guide bars 23, 24 and collide with the stopper 292. When a collision between the pick-up unit 22 and the impact-reducing mechanism 29 occurs, the stopper 292 would transmit the impact of the pick-up unit 22 through the guide bar 24 to the buffer 291, and the buffer 291 would absorb the impact via deformation, thereby protecting the pick-up unit 22.

In all the described embodiments, the impact-reducing mechanism is disposed at an end of the guide bar 24. It is understood that the impact-reducing mechanism can also be disposed at either or both ends of the guide bars 23, 24 to protect the pick-up unit 22.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical disk drive comprising:
a core body having an operating zone;
a guide bar connected to the core body;
a pick-up unit movably supported by the guide bar to access an optical disk in the operating zone; and
an impact-reducing mechanism disposed outside the operating zone;
wherein when the pick-up unit moves outside the operating zone and collides with the impact-reducing mechanism, the impact-reducing mechanism sustains an impact of the pick-up unit.

2. The optical disk drive as claimed in claim 1, wherein the impact-reducing mechanism includes a helical spring wound around the guide bar.

3. The optical disk drive as claimed in claim 2, wherein the helical spring includes a first end fixed to the core body and a second end left free to sustain the impact of the pick-up unit.

4. The optical disk drive as claimed in claim 2, wherein the core body further has a protrusion, and the helical spring includes a first end hooked to the protrusion and a second end left free to sustain the impact of the pick-up unit.

5. The optical disk drive as claimed in claim 2, wherein the core body further has a holder holding the guide bar.

6. The optical disk drive as claimed in claim 5, wherein the helical spring abuts the holder.

7. The optical disk drive as claimed in claim 2, wherein the helical spring is made of metal.

8. The optical disk drive as claimed in claim 1, wherein the impact-reducing mechanism includes a spring band extending from the core body to the guide bar, sustaining the impact of the pick-up unit.

9. The optical disk drive as claimed in claim 8, wherein the spring band has a notch through which the guide bar passes.

10. The optical disk drive as claimed in claim 8, wherein the spring band is made of metal.

11. The optical disk drive as claimed in claim 1, wherein the impact-reducing mechanism includes a buffer and a stopper, the buffer is disposed between the guide bar and the core body, and the stopper is connected to the guide bar for transmitting the impact of the pick-up unit through the guide bar to the buffer.

12. The optical disk drive as claimed in claim 11, wherein the stopper is closer to the pick-up unit than the buffer.

13. The optical disk drive as claimed in claim 11, wherein the buffer covers an end of the guide bar and abuts the core body.

14. The optical disk drive as claimed in claim 11, wherein the buffer is made of rubber.

15. The optical disk drive as claimed in claim 11, wherein the stopper is ring-shaped and wound around the guide bar.

16. The optical disk drive as claimed in claim 11, wherein the stopper is made of metal.
